(19) United States
(12) Patent Application Publication
(10) Pub. No.: US 2024/0286103 A1
(43) Pub. Date: Aug. 29, 2024

(54) Resin Containing Aqueous Inkjet Ink and Recording Method

(71) Applicant: Agfa NV, Mortsel (BE)

(72) Inventors: Johan Loccufier, Mortsel (BE); Hubertus Van Aert, Mortsel (BE); Ellen Bertels, Mortsel (BE); Fabienne Goethals, Mortsel (BE)

(73) Assignee: Agfa NV, Mortsel (BE)

(21) Appl. No.: 18/571,812

(22) PCT Filed: Jun. 16, 2022
(86) PCT No.: PCT/EP2022/066491

§ 371 Date: Dec. 19, 2023

(30) Foreign Application Priority Data
Jun. 21, 2021 (EP) 21180513.0

(51) Int. Cl. B01J 13/16; C09D 7/65; C09D 11/322; C09D 11/54

(52) U.S. Cl. CPC B01J 13/16; C09D 11/322; C09D 11/54; C09D 7/65

(57) ABSTRACT

An aqueous dispersion of a microcapsule, comprising a crosslinked polymeric shell surrounding a core, the core comprises a second polymer which is non-polymerizable. The dispersion is useful in aqueous pigment containing inkjet inks or pre-treatment liquids for inkjet printing on low-absorbing or non-absorbing substrates.

### TECHNICAL FIELD

The present invention relates to aqueous inkjet inks or pre-treatment liquids comprising microcapsules having a core containing a resin for use in inkjet printing on low-absorbing or non-absorbing substrates.

### BACKGROUND ART

Images, printed on non-absorbing and semi-absorbing substrates have to meet a whole set of requirements, including an excellent adhesion performance, water and solvent resistance, chemical resistance and rub resistance. In order to meet these requirements, additional resins or polymers are integrated into aqueous ink jet inks which function as a binder. In several applications, the substrates used are temperature sensitive, limiting the drying and optionally curing temperatures that can be used. Depending on requirements for a specific application, different resin technologies, compatible with temperature sensitive substrates, have been disclosed in the prior art.

Latex based approaches have been disclosed in the patent literature (see WO2018/114314A, US 2013/0245157A1 and EP3275949A1), having binding capability to fulfil some requirements on physical properties for several applications. However, latex based inkjet inks do generally not improve simultaneously water resistance and rub resistance of printed images on low absorbing substrates such as corrugated card board or non-absorbing substrates. Furthermore, latex based ink jet inks have a tendency for film formation in the nozzles of the print head and in the ink supplies, leading to reliability problems during printing. In industrial applications, system reliability and especially jetting reliability is of utmost importance. Therefore, there was still a need for more optimal resin technologies

In WO 2016/165956 aqueous resin based inkjet inks are described wherein the resin is present as a capsule. To achieve good binding properties and hence durable printed images, reactive chemistry such as blocked isocyanates is incorporated in the core of the capsule. The presence of such reactants may give health and safety issues when not completely reacted in the obtained image. Moreover, the release of the reactive chemistry from the core, requires a thermal activation step during or after drying the ink. The thermal activation step comprises the heating of the printed image up to temperatures above 100° C. which is not compatible with poly(olefin) based substrates such as polyethylene or polypropylene films.

US2019/0023922 discloses inkjet inks containing capsules having a core which comprises polymerisable compounds such as a polymerisable oligomer or polymer. The polymerisable compounds are polymerized only upon applying UV-light or upon the presence of blocked isocyanates. The requirement of a UV-light source or heating source for activating the blocked isocyanates, create an additional complexity in the design of reliable inkjet printing systems.

Polymerisable polymers having reactive functional groups, are known to have reactivity towards typical shell monomers used in interfacial polymerization such as isocyanates, especially from a moderate alkaline pH onwards. This reactivity towards shell monomers, limits the latitude for encapsulation of these polymers based on interfacial polymerization, which is a concern for industrialization and scalability. Latitude in the industrialization of the core shell particles is of key importance to avoid loss in production, leading to significant economic and ecologic losses.

Therefore, there is still a need for a resin technology for ink jet printing applications, combining excellent physical properties in the end application and jetting reliability on one hand with reliable industrialization on the other hand.

### SUMMARY OF THE INVENTION

It is the objective of the present invention to provide a solution to the above stated problem. The objective has been achieved by providing an aqueous inkjet ink or other inkjet printing liquid such as pre-treatment liquids, comprising capsules as defined in claim 1.

It is further an object of the present invention to provide a method of preparing the above mentioned capsules as defined in claim 9.

It is another embodiment of the invention to provide a printing method using inkjet inks comprising capsules of claim 1 as defined in claim 10.

Other features, elements, steps, characteristics and advantages of the present invention will become more apparent from the following detailed description of preferred embodiments of the present invention. Specific embodiments of the invention are also defined in the dependent claims.

### DESCRIPTION OF EMBODIMENTS

### A. Aqueous Dispersion of a Microcapsule

### A.1. Microcapsule

The objectives of the present invention are realized by an aqueous dispersion of a microcapsule comprising a core surrounded by a polymeric shell, wherein the core comprises a second polymer which is substantially free of an ethylenically unsaturated group, an epoxy group, an isocyanate group or an active methylene group.

### A.1.1. Second Polymer

The second polymer is a polymer which is substantially free of a reactive group selected from the group consisting of an ethylenically unsaturated group, an epoxy group, an isocyanate group, a β-keto-ester, a β-keto-amide and a 1,3-diketone. Due to the absence of these groups, the second polymer is non-polymerisable and hence not able to react with the shell monomers (see § A.1.2 and § A.2.)

Example of an ethylenically unsaturated group, is a (meth)acrylic group, a vinyl group, an allyl group and a styryl group.

In principle any known second polymer can be used in the present invention. Preferably, the second polymer is soluble in substantial water immiscible organic solvents. In a preferred embodiment, the second polymer is selected from the group consisting of poly(urethane)s and copolymers thereof, acrylics and copolymers thereof, poly(ester)s and copolymers thereof, poly(styrene)s and copolymers thereof, poly(vinyl amide)s and copolymers thereof, poly(olephine)s and copolymers thereof, poly(vinyl alcohol) derivatives and copolymers thereof, poly(acetals) and copolymers thereof, poly(ethers) and copolymers thereof, polyamides and copolymers thereof, poly(imides) and copolymers thereof, poly(imines) and copolymers thereof, polycarbonates and copolymers thereof, poly(vinyl chloride) and copolymers thereof, poly(vinylidene chloride) and copolymers thereof, poly(amic acids) and copolymers thereof, poly(saccharides) and derivatives thereof, cellulose and derivatives thereof and combinations thereof. Derivatives of poly(saccharides) and cellulose are esters and ethers as disclosed in https://en.wikipedia.org/wiki/Cellulose. They comprise cellulose acetate, cellulose triacetate, Cellulose propionate, Cellulose acetate propionate (CAP), Cellulose acetate butyrate (CAB), Nitrocellulose (cellulose nitrate), Cellulose sulfate, methylcellulose, ethylcellulose, ethyl methyl cellulose, hydroxyethyl cellulose, hydroxypropyl cellulose, hydroxyethyl methyl cellulose, hydroxypropyl methyl cellulose, ethyl hydroxyethyl cellulose, carboxymethyl cellulose.

Poly(urethanes) and acrylics are particularly preferred. Acrylics are defined as polymeric resins obtained by polymerization or copolymerization of acrylates, methacrylates, acrylamides and methacrylamides. In the present invention, acrylate and methacrylate based polymers and copolymers are particularly preferred.

In a preferred embodiment, the second polymer and the first shell monomer such as a polyisocyanate, are mixed prior to the high shear treatment of the interfacial polymerization. The second polymer should then be preferably soluble in the organic solvents forming the oleophilic phase in the interfacial polymerization (see § A.2.) or should have at least segments which are soluble or swellable in the organic solvents.

Segmented second polymers, such as graft- or block copolymers, where the different segments have a different solubility in the organic solvent can be used. The presence of hydrophilic segments such as in graft copolymers with polyether chains in the second polymer, seems to be helpful in obtaining microcaps having a particle size of less than 500 nm, even less than 200 nm.

When the second polymer is a polyurethane, the incorporation of the hydrophilic grafts can be accomplished by means of copolymerization of polyether diols. When the second polymer is a polyacrylate, the incorporation of hydrophilic grafts can be accomplished by graft copolymers of methacryl terminated polyethylene glycol. Examples are a polyethylene glycol functional polyacrylate copolymer such as Byk LPG21241, or polyethylene glycol based block copolymers which are well soluble in the organic phase (ethyl acetate). Such block copolymers contain then besides the water compatible polyether chains also segments which are insoluble in water (e.g. polyester, polyether).

Suitable polyether diols in the present invention, are Ymer N120, Ymer N90 or Tegomer D 3403, i.e. α-[2,2-bis(hydroxymethyl)butyl]-ω-methoxy-Poly(oxy-1,2-ethanediyl). These diols can be prepared from trimethylol propane oxetane (TMPO). A possible synthesis procedure is described by Fock, J.; Möhring, V., Polyether-1,2-and-1,3-diols as macromonomers for the synthesis of graft copolymers, 1. Synthesis and characterization of the macromonomers. Die Makromolekulare Chemie 1990, 191 (12), 3045-3057. In general, also other polyether 1,2- or 1,3-diols can be used.

It was observed that also the length of the polyether chain incorporated in the second polymer determines the water resistance of the printed images. A shorter polyether chain such as with Ymer N90 is more preferable than a longer polyether chain such as with Ymer N180. The second polymer according to the present invention can be prepared according to any polymerization method known in the art, including free radical polymerization, cationic polymerization, anionic polymerization, ring opening polymerization, metathesis polymerization and polycondensations. In resins prepared using free radical polymerisation, the molecular weight of the resins can be controlled using RAFT agents, ATRP, nitroxyl radical technology or transfer agents, preferably thiols.

The second polymer can be a poly(ester). Suitable poly(esters) can be selected from the group consisting of copolymers of dicarboxylic acids like terephtalic acid, isophalic acid, adipic acid, succinic acid or alkylesters thereof or copolymers prepared by ringopening polymerisation of cyclic esters, such as caprolactone or cyclic diesters like DL-lactide.

Suitable poly(ethers) as second polymer can be selected from the group consisting of polyalkylene oxides or copolymers, polyphenylene oxide, polystyrene oxide and polyTHF.

Suitable poly(acetals) as second polymer can be selected from the group consisting of poly(vinyl butyral), polyvinylacetaldehyde, and reaction products of hydroxyfunctional polymers with aliphatic or aromatic aldehydes.

Suitable poly(urethanes) as second polymer can be obtained by polymerization of di- or polyisocyanates with diols. Typical di-isocyanates can be selected from the group consisting of isophorone diisocyanate (IPDI), 4,4′-dicyclohexylmethane diisocyanate (H12MDI), 2,4,4′-trimethyl-1,6-hexamethylene diisocyanate (TMDI), hexamethylene diisocyanate (HMDI), pentamethylene diisocyanate (PDI), tolylene diisocyanate (TDI), xylene diisocyanate (XDI) and diphenylmethane diisocyanate (MDI).

Diols can be low molecular weight compounds but oligomeric diols are particularly preferred. Typical oligomeric diols can be selected from the group consisting of polyester polyols, polyether polyols, polyamide polyols, polyacrylate polyols, polycarbonate polyols and polyolefine polyols.

Suitable acrylics as second polymer are obtained by polymerization of monomers selected from the group consisting of ethylacrylate, butylacrylate, methylmethacrylate, ethylmethacrylate, methyl acrylate, butylmethacrylate, 2-ethylhexyl acrylate, 2-ethylhexyl methacrylate, stearyl acrylate, stearyl methacrylate, lauryl acrylate, lauryl methacrylate, cetyl acrylate, cetyl methacrylate, cyclohexyl acrylate, cyclohexyl methacrylate, isopropyl acrylate, isopropyl methacrylate and copolymers of acrylic or methacrylic monomers with monomers selected from the group consisting of alpha-methylstyrene, vinylacetate, vinyl versatate, butadiene, isoprene, acrylonitrile, methacrylonitrile, styrene, para-methylstyrene, tert.-butylstyrene, butyl vinylether, hydroxybutyl vinylether and ethylene.

The second polymer preferably has a weight average molecular weight (M_{w}) between 500 g/mol and 400.000 g/mol, more preferably between 1000 g/mol and 100.000 g/mol and most preferably between 2000 g/mol and 50.000 g/mol.

The second polymer preferably has a numeric average molecular weight (Mn) between 300 g/mol and 200.000 g·mol, more preferably between 1000 g/mol and 50.000 g/mol and most preferably between 1000 and 30.000 g/mol.

### A.1.2. Polymeric Shell

The polymeric shell encapsulates the second polymer and may also assure the dispersibility of the microcapsule in the aqueous vehicle of an inkjet ink or pre-treatment liquid.

There is no real limitation on the type of polymer in the polymeric shell of the capsule. Preferably, the polymer is cross-linked. By crosslinking, more rigidity is built into the capsules allowing a broader range of temperatures and pressures for handling the capsules in both the ink making and in the inkjet printing equipment.

Preferred examples of the polymeric shell material include polyureas, polyurethanes, polyesters, polycarbonates, polyamides, polysulphonamides, melamine based polymers, silica based sol-gel polymers or mixtures thereof such as in U.S. Pat. No. 603,149B1, with polyureas and polyurethanes being especially preferred, polyurea being the most preferred.

The particles are preferably present in an aqueous inkjet ink or pre-treatment liquid in an amount of no more than 45 wt. %, preferably between 5 and 25 wt. % based on the total weight of the ink or liquid. It was observed that above 30 wt. % jetting was not always so reliable.

The capsules are dispersed in the aqueous medium of the inkjet ink or the pre-treatment liquid preferably via a dispersing group covalently bonded to the polymeric shell or are dispersed by using dispersants or surfactants preferably added during or after the formation of the capsule.

The dispersing group covalently bonded to the polymeric shell, is preferably selected from the group consisting of a carboxylic acid or salt thereof, a sulfonic acid or salt thereof, a phosphoric acid ester or salt thereof, a phosphonic acid or salt thereof.

The dispersing group can be used in combination with a polymeric dispersant in order to accomplish steric stabilization. For example, the polymeric shell may have covalently bonded carboxylic acid groups that interact with amine groups of a polymeric dispersant. However, in a more preferred embodiment, no polymeric dispersant is used and dispersion stability of the inkjet ink is accomplished solely by electrostatic stabilization. For example, a slightly alkaline aqueous medium will turn the carboxylic acid groups covalently bonded polymeric shell into ionic groups, whereafter the negatively charged capsules have no tendency to agglomerate. If sufficient dispersing groups are covalently bonded to the polymeric shell, the capsule becomes a so-called self-dispersing capsule.

These negatively charged capsule surfaces can also be advantageously used during inkjet printing. For example, a second liquid such as a pre-treatment liquid containing a cationic substance, being a cationic polymer or multivalent salt, can be used to precipitate the anionic capsules in the inkjet ink printed on top of the second liquid. By using this method an improvement in image quality can be observed due to the immobilisation of the capsules of the ink.

The dispersing group covalently bonded to the polymeric shell to be incorporated in a pre-treatment liquid is preferably selected from the group consisting of a protonated amine, a protonated nitrogen containing heteroaromatic compound, a quaternized tertiary amine, a N-quaternized heteroaromatic compound, a sulfonium and a phosphonium.

The capsules to be used in a jettable aqueous formulation such as an inkjet ink or jettable pre-treatment liquid, have an average particle size of no more than 4 μm as determined by dynamic laser diffraction. The nozzle diameter of inkjet print heads is usually 20 to 35 μm. Reliable inkjet printing is possible if the average particle size of the capsules is five times smaller than the nozzle diameter. An average particle size of no more than 4 μm allows jetting by jetting heads having the smallest nozzle diameter of 20 μm. In a more preferred embodiment, the average particle size of the capsules is ten times smaller than the nozzle diameter. Hence preferably, the average particle size is from 0.05 to 2 μm, more preferably from 0.10 to 1 μm. When the average particle size of the capsule is smaller than 2 μm, excellent resolution and dispersion stability with time are obtained.

### A.2. Preparation of the Microcapsule Dispersion

The microcapsule dispersion according to the invention can be prepared using both chemical and physical methods. Suitable encapsulation methodologies include complex co-acervation, liposome formation, spray drying and polymerization methods.

In the present invention preferably a polymerization method is used, as it allows the highest control in designing the capsules. More preferably interfacial polymerization is used to prepare the capsules of the invention. This technique is well-known and has been reviewed by Zhang Y. and Rochefort D. (Journal of Microencapsulation, 29(7), 636-649 (2012) and by Salitin (in Encapsulation Nanotechnologies, Vikas Mittal (ed.), chapter 5, 137-173 (Scrivener Publishing LLC (2013)).

In interfacial polymerization, such as interfacial polycondensation, two reactants meet at the interface of the emulsion droplets and react rapidly.

In general, interfacial polymerization requires the emulsion of an oleophilic phase in an aqueous continuous phase or vice versa. The oleophilic phase is preferably obtained by using a substantially water immiscible organic solvent. Each of the phases contains at least one dissolved monomer (a first shell monomer) that is capable of reacting with another monomer (a second shell monomer) dissolved in the other phase. Upon polymerisation, a polymer is formed that is insoluble in both the aqueous and the oleophilic phase. As a result, the formed polymer has a tendency to precipitate at the interface of the oleophilic and aqueous phase, hereby forming a shell around the dispersed phase, which grows upon further polymerisation. The capsules according to the present invention are preferably prepared from an oleophilic emulsion in an aqueous continuous phase.

Typical polymeric shells of the capsules according to the invention and formed by interfacial polymerisation are selected from the group consisting of polyamides, typically prepared from di- or poly-acid chlorides as first shell monomers and di- or oligoamines as second shell monomers, polyurea, typically prepared from di- or oligoisocyanates as first shell monomers and di- or oligoamines as second shell monomers, polyurethanes, typically prepared from di- or oligoisocyanates as first shell monomers and di- or oligoalcohols as second shell monomers, polysulfonamides, typically prepared from di- or oligosulfochlorides as first shell monomers and di- or oligoamines as second shell monomers, polyesters, typically prepared from di- or oligo-acid chlorides as first shell monomers and di- or oligoalcohols as second shell monomers and polycarbonates, typically prepared from di- or oligo-chloroformates as first shell monomers and di- or oligoalcohols as second shell monomers. The shell can be composed of combinations of these polymers.

In a preferred embodiment of the invention, interfacial polymerization is performed and a polyurea shell is formed at the interface. Preferably, the first shell monomer is a polyisocyanate present in the oleophilic phase, while polyamines are present in the aqueous phase as the second shell monomer and which acts as a crosslinker. Polyamines are preferred whereas polyols show a much slower reaction rate. Alternatively, the second shell monomer can be omitted as water can react with the isocyanate moiety and can form an amine. This in-situ formed amine can then further react with another isocyanate moiety present in the polyisocyanate. So even without adding a second shell monomer a crosslinked polyurea shell can be obtained.

Different chemistries can be used as suitable polyisocyanates. The structure and reactivity of the polyisocyanate, its molecular weight and viscosity is important in the process of producing small droplets under high shear.

When emulsifying the water immiscible solvent in the aqueous phase, the breaking up of the droplets is dependent on the viscosity of the solvent and water phase. Highest shear forces can usually be applied when the viscosity of the water immiscible solvent and the water phase are close to each other. Therefore, also polyisocyanates having lower molecular weights give better results in reducing the droplet size by high shear. Smaller droplet size of the oleophilic phase (obtained by the water immiscible solvent, the second polymer and the polyisocyanate) lead to capsules having a smaller particle size.

The ratio water immiscible solvent/water is also of importance. When adding too much water (>65 wt. %) during the dispersing step, the viscosity is not only lower to obtain higher shear forces but also part of the water immiscible solvent will partially go into the aqueous phase. In case of a second polymer or polyisocyanate having a low solubility in the water immiscible solvent, a too low water immiscible solvent concentration during the high shear dispersing step will result in particles having a greater particle size.

Furthermore, the concentration of the polyisocyanate, the added second polymer and in particular, the ratio of water immiscible solvent phase/aqueous phase determines the oleophilic droplet sizes during the high shear treatment. The amount of the isocyanate groups in the polyisocyanate, their reactivity and the concentration of the second shell monomer in the aqueous phase, preferably a polyamine, determines the crosslinking density of the polymeric shell.

The type of solvent forming the oleophilic phase in the interfacial polymerization, is important to obtain an industrial scalable process. Preferably an organic solvent is used with a low boiling point which can be easily removed, such as ethyl acetate or methylene chloride. Preferably the organic solvent has a boiling point lower than that of water.

The type of polyisocyanate has a significant effect on the microcapsule formation. Suitable polyisocyanates can be monomeric isocyanates, biuret structures, urethione, allophanate, isocyanurate trimer, isocyanate adducts or (partially) modified polyisocyanates.

Examples of modified polyisocyanates are hydrophilic isocyanates such as polyether modified polyisocyanates, e.g Bayhudur 3100, Bayhydur 305, Bayhydur XP2451/1.

The reactivity of isocyanates is dependent on the structure. Aromatic isocyanates are more reactive than aliphatic isocyanates. Reactivity is further reduced by steric hindrance in isocyanate groups. The structure of the polyisocyanate will also determine the final mechanical properties of the shell. A polyisocyanate with a lot of sp³ hybridized carbon atoms in its structure will result in a more flexible shell than a polyisocyanate with little sp³ carbon atoms.

Ionic polyisocyanates can also be used but are less preferred due the reduced solubility in organic solvents such as ethyl acetate, e.g Bayhydur XP2547 or Bayhydur XP2700.

Besides the type of second polymer, the type of isocyanate present in the polyisocyanate also determines the adhesion properties of the inkjet inks or pre-treatment liquid on non-absorbing substrates. E.g. hexamethylene diisocyanate (HDI) offers a higher flexibility of the printed image than isophorone diisocyanate (IPDI).

Optimized properties such as dispersibility in water and reactivity with amines, could be obtained using polyisocyanates based on mixtures of monomeric isocyanates. The use of mixtures of HDI and IPDI in polyisocyanates is quite common. The polyisocyanates can be based on the following monomeric isocyanates: isophorone diisocyanate (IPDI), 4,4′-dicyclohexylmethane diisocyanate (H12MDI), 2,4,4′-trimethyl-1,6-hexamethylene diisocyanate (TMDI), hexamethylene diisocyanate (HMDI), pentamethylene diisocyanate (PDI), tolylene diisocyanate (TDI), xylene diisocyanate (XDI) and diphenylmethane diisocyanate (MDI).

When highly reactive second shell monomers are used in the aqueous phase, one could first emulsify the oleophilic phase with high shear to small droplet size and consequently add the second shell monomer (e.g polyamine) to the emulsion to prevent a too early polymerization. When the second shell monomer has a low reactivity, the second shell monomer can be added prior to the emulsifying step.

Modified polyisocyanates are also suitable in the preparation of the microcapsules of the invention. Examples are reaction products of diisocyanates or polyisocyanates with alcohols, such as TMP=trimethylol propane or alcohol terminated polymers such as mono-alkoxy terminated polyethylene glycol.

In a further embodiment, polymers such as gelatine, chitosan, albumin and polyethylene imine can be used as second shell monomers in combination with a di- or oligo-isocyanate, a di- or oligo acid chloride, a di- or oligo-chloroformate and an epoxy resin as first shell monomer.

In a particularly preferred embodiment, the shell is composed of a polyurea or a combination thereof with a polyurethane. In a further preferred embodiment, a substantial water immiscible solvent is used in the dispersion step, which is removed by solvent stripping before or after the shell formation. In a particularly preferred embodiment, the water immiscible solvent has a boiling point below 100° C. at normal pressure. Esters and ketones are particularly preferred as water immiscible solvent.

A substantial water immiscible solvent is an organic solvent having low miscibility in water. Low miscibility is defined as any water solvent combination forming a two phase system at 20° C. when mixed in a one over one volume ratio.

The core of the microcap contains the second polymer. This is usually incorporated into the capsules by dissolving it in the organic solvent having low miscibility with water and having a lower boiling point than water. A preferred organic solvent is ethyl acetate, because it also has a low flammability hazard compared to other organic solvents.

The method for preparing the dispersion of capsules according to the invention, preferably includes the following steps:
a) preparing a non-aqueous solution of a first shell monomer for forming the polymeric shell and the second polymer in a substantial water immiscible organic solvent and preferably having a lower boiling point than water;
b) preparing an aqueous solution of an emulsifier and optionally a second shell monomer for forming the polymeric shell;
c) emulsifying the non-aqueous solution under high shear in the aqueous solution;
d) optionally stripping the organic solvent from the mixture of the aqueous solution and the non-aqueous solution; and
e) optionally adding water that is removed during evaporation to obtain a desired capsule concentration; and
f) formation of a polymeric shell by initiating the interfacial polymerization of the first shell monomer, e.g. by a temperature increase, the addition of a catalyst, or by UV-irradiation.

The second shell monomer or crosslinker can be added to the emulsion in advance to or after the high shear dispersing step. The initiation of the interfacial polymerization happens mostly spontaneously at room temperature, so no initiation is required. The emulsifier can also become part of the polymeric shell when the emulsifier is reactive such as in a preferred embodiment of the invention.

Sometimes, when using self-dispersing second polymers, polyisocyanates or very efficient emulsifiers, the high shear emulsifying step can be performed by normal stirring.

In an even more preferred embodiment, the dispersion of microcapsules according to the present invention is prepared according to a method comprising the following steps:
a) preparing a second polymer according to the present invention in a substantially water immiscible solvent such as to form an non-aqueous solution;
b) adding a first shell monomer to the non-aqueous solution of the second polymer;
c) preparing an aqueous solution of an emulsifier and optionally a second shell monomer for forming the polymeric shell;
d) emulsifying the non-aqueous solution under high shear in the aqueous solution;
e) optionally stripping the organic solvent from the mixture of the aqueous solution and the non-aqueous solution; and
f) formation of a polymeric shell by interfacial polymerization of the first component. This happens spontaneously or can be initiated by a temperature increase, the addition of a catalyst, or by UV-irradiation.

The capsule dispersion can then be completed into an aqueous inkjet ink or pre-treatment liquid, by addition of e.g, colorants, water, humectants, surfactants, solvents and the like.

A preferred strategy to incorporate anionic stabilizing groups into the polymeric shell of a capsule makes use of carboxylic acid functionalized reactive surfactants that are capable of reacting with isocyanates. This leads to an amphoteric type of surfactant containing at least partially secondary or primary amines. Other reactive surfactants functionalized with a sulfonic acid or salt thereof, a phosphoric acid ester or a salt thereof or a phosphonic acid or salt thereof can be used.

Several amphoteric surfactants, being mixtures of surfactants partially having secondary amines but also comprising tertiary amines are commercially available. Prohibitive foam formation in ink jet inks based on capsules made by using the commercially available amphoteric surfactants was encountered in an inkjet printer. Foaming caused problems in the ink supply and also in the degassing for trying to remove air from the ink, thus leading to unreliable jetting. Therefore, surfactants according to Formula (I) of WO2016/165970 are preferably used during the encapsulation process of the second polymer.

The capsules according to the invention are dispersed into an aqueous medium. The aqueous medium consists of water, but may preferably include one or more water-soluble organic solvents.

The one or more organic solvents may be added for a variety of reasons. For example, it can be advantageous to add a small amount of an organic solvent to improve the dissolution of a compound in the inkjet ink to be prepared, to obtain better penetration in porous substrates or to prevent fast drying of ink at the nozzle of the inkjet head. Preferable water-soluble organic solvents are polyols (e.g., ethylene glycol, glycerin, 2-ethyl-2-(hydroxymethyl)-1,3-propanediol, tetraethylene glycol, triethylene glycol, tripropylene glycol, 1,2,4-butanetriol, diethylene glycol, propylene glycol, dipropylene glycol, butyleneglycol, 1,6-hexanediol, 1,2-hexanediol, 1,5-pentanediol, 1,2-pentanediol, 2,2-dimethyl-1,3-prapanediol, 2-methyl-2,4-pentanediol, 3-methyl-1,5-pentanediol, 3-methyl-1,3-butanediol, and 2-methyl-1,3-propanediol), N-hydroxyethyl-pyrrolidon, N-butyl-pyrrolidon, amines (e.g., ethanolamine, and 2-(dimethylamino)ethanol), monohydric alcohols (e.g., methanol, ethanol, and butanol), alkyl ethers of polyhydric alcohols (e.g., diethylene glycol monomethyl ether, diethylene glycol monobutyl ether, triethylene glycol monomethyl ether, triethylene glycol monobutyl ether, ethylene glycol monomethyl ether, ethylene glycol monobutyl ether, propylene glycol monomethyl ether, propylene glycol monobutyl ether, and dipropylene glycol monomethyl ether), 2,2′-thiodiethanol, amides such as N,N-dimethylformamide, heterocycles such as 2-pyrrolidone and N-methyl-2-pyrrolidone, and acetonitrile.

### B. Aqueous Formulations Comprising the Dispersion of the Invention.

### B.1. Pre-Treatment Liquid

Aqueous pre-treatment liquids are preferably used in inkjet printing with aqueous based inks onto low-absorbing or non-absorbing substrates. The aqueous pre-treatment liquid according to the invention comprises a microcapsule consisting of a polymeric shell surrounding a core, the core comprises a second polymer. The polymeric shell preferably further comprises a dispersing group, preferably covalently bonded to the shell, more preferably, the dispersing group is a group selected from the group of a protonated amine, a protonated nitrogen containing heteroaromatic compound, a quaternized tertiary amine, a N-quaternized heteroaromatic compound, a sulfonium and a phosphonium.

The cationic dispersing groups will help in aggregation, flocculating, precipitation or crashing the anionic stabilized colorants and/or binders in the aqueous inkjet ink leading to a reduced bleeding and beading in the formed image. The capsules are preferably present in an amount of no more than 45 wt. %, more preferably between 5 and 25 wt. % based on the total weight of the pre-treatment liquid. It was observed that above 30 wt. %, jetting was not always reliable.

A multivalent metal ion can be contained in the pre-treatment liquid as a compound capable of precipitating or aggregating anionic compounds from the inkjet ink such as dyes, pigments and binders. Suitable examples are water-soluble metal salts formed from bi- or higher valent metal cations, such as magnesium, calcium, strontium, barium, zirconium, and aluminum, and anions, such as a fluoride ion (F⁻), a chloride ion (Cl⁻), a bromide ion (Br⁻), a sulfate ion (SO₄²⁻), a nitrate ion (NO₃⁻), and an acetate ion (CH₃COO⁻).

These polyvalent metal ions have a function of aggregating ink by acting on the carboxyl groups on the surface of the pigment in the ink jet ink, or on the dispersed polymer of capsules contained in the ink. As a result, the colorants of the ink are fixed resulting in a decreased bleeding and beading in the printed image. Therefore, it is preferred that the surface of the pigment in the ink and/or the dispersed polymer of the capsules, if contained in the ink, have an anionic group, preferably a carboxyl group.

The pre-treatment liquid may also contain pigments. Particularly useful for printing on dark or transparent substrates, is a pre-treatment liquid containing a white pigment. The preferred pigment for the aqueous pre-treatment liquid ink is titanium dioxide. Titanium dioxide (TIO₂) pigment useful in the present invention may be in the rutile or anastase crystalline form. Processes for making TiO₂ are described in greater detail in “The Pigment Handbook”, Vol. I, 2nd Ed., John Wiley & Sons, NY (1988), the relevant disclosure of which is incorporated by reference herein for all purposes as if fully set forth.

The titanium dioxide particles can have a wide variety of average particle sizes of about 1 micron or less, depending on the desired end use application of the pre-treatment liquid. For applications demanding high hiding or decorative printing applications, the titanium dioxide particles preferably have an average size of less than about 1 μm. Preferably, the particles have an average size of from about 50 to about 950 nm, more preferably from about 75 to about 750 nm, and still more preferably from about 100 to about 500 nm.

For applications demanding white colour with some degree of transparency, the pigment preference is “nano” titanium dioxide. “Nano” titanium dioxide particles typically have an average size ranging from about 10 to about 200 nm, preferably from about 20 to about 150 nm, and more preferably from about 35 to about 75 nm. An ink comprising nano titanium dioxide can provide improved chroma and transparency, while still retaining good resistance to light fade and appropriate hue angle. A commercially available example of an uncoated nano grade of titanium oxide is P-25, available from Degussa (Parsippany N.J.).

In addition, unique advantages may be realized with multiple particle sizes, such as opaqueness and UV protection. These multiple sizes can be achieved by adding both a pigmentary and a nano grade of TIO₂.

The titanium dioxide is preferably incorporated into the pre-treatment formulation via a slurry concentrate composition. The amount of titanium dioxide present in the slurry composition is preferably from about 15 wt. % to about 80 wt. %, based on the total slurry weight.

The titanium dioxide pigment may also bear one or more metal oxide surface coatings. These coatings may be applied using techniques known by those skilled in the art. Examples of metal oxide coatings include silica, alumina, aluminasilica, boria and zirconia, among others. These coatings can provide improved properties including reducing the photoreactivity of the titanium dioxide. Metal oxide coatings of alumina, aluminasilica, boria and zirconia result in a positive charged surface of the TiO₂ pigments and hence are particularly useful in combination with the cationic stabilised capsules of the invention because no additional surface treatment of the pigment is required.

Commercial examples of such coated titanium dioxides include R700 (alumina-coated, available from E.I. DuPont deNemours, Wilmington Del.), RDI-S(alumina-coated, available from Kemira Industrial Chemicals, Helsinki, Finland), R706 (available from DuPont, Wilmington Del.) and W-6042 (a silica alumina treated nano grade titanium dioxide from Tayco Corporation, Osaka Japan).

The pre-treatment liquid may contain at least one pH adjuster. Suitable pH adjusters include organic amines, NaOH, KOH, NEt₃, NH₃, HCl, HNO₃ and H₂SO₄. In a preferred embodiment, the pre-treatment liquid has a pH lower than 7. A pH of 7 or less can advantageously influence the electrostatic stabilization of the capsules, especially when the dispersing groups of the capsules are amines.

### B.2. Aqueous Inkjet Ink.

The aqueous inkjet ink according to the present invention includes at least a) an aqueous medium; and b) a colorant and c) a capsule consisting of a polymeric shell surrounding a core, the core comprises a second polymer. The polymeric shell may further comprise a dispersing group, preferably covalently bonded to the shell, more preferably, the dispersing group is a group selected from the group consisting of a carboxylic acid or salt thereof, a sulfonic acid or salt thereof, a phosphoric acid ester or salt thereof, a phosphonic acid or salt thereof. A combination of both an anionic and a non-ionic dispersing group linked to the polymeric shell can also be used to stabilise the capsule in an inkjet ink.

The resin particles according to the invention are preferably present in the inkjet ink in an amount of no more than 30 wt. %, preferably between 2 and 25 wt. % based on the total weight of the inkjet ink. It was observed that above 30 wt. % jetting was not always so reliable.

In a preferred embodiment, the inkjet ink according to the invention is part of an inkjet ink set, more preferably part of a multi-colour inkjet ink set including a plurality of inkjet inks according to the invention. The inkjet ink set preferably includes at least a cyan inkjet ink, a magenta inkjet ink, a yellow inkjet ink and a black inkjet ink. Such a CMYK-inkjet ink set may also be extended with extra inks such as red, green, blue, violet and/or orange to further enlarge the colour gamut of the image. The inkjet ink set may also be extended by the combination of the full density inkjet inks with light density inkjet inks. The combination of dark and light colour inks and/or black and grey inks improves the image quality by a lowered graininess.

In a preferred embodiment, the inkjet ink set also includes a white inkjet ink. This allows obtaining more brilliant colours, especially on transparent substrates, where the white inkjet ink can be applied either as a primer, on top of a primer containing cationic compounds or on top of the colour inkjet inks when the image is viewed through the transparent substrate.

The viscosity of the inkjet ink is preferably smaller than 25 mPa·s at 25° C. and at a shear rate of 90 s⁻¹, more preferably between 2 and 15 mPa·s at 25° C. and at a shear rate of 90 s⁻¹.

The surface tension of the inkjet ink is preferably in the range of about 18 mN/m to about 70 mN/m at 25° C., more preferably in the range of about 20 mN/m to about 40 mN/m at 25° C.

The inkjet ink may also contain at least one surfactant for obtaining good spreading characteristics on a substrate.

### B.2.1. Solvent

The aqueous medium of the ink contains water, but may preferably include one or more water-soluble organic solvents. Suitable solvents which can be incorporated in the inks are described in § A.2.

### B.2.2. Pigments

The pigments of the aqueous inkjet ink may be black, white, cyan, magenta, yellow, red, orange, violet, blue, green, brown, mixtures thereof, and the like. A colour pigment may be chosen from those disclosed by HERBST, Willy, et al. Industrial Organic Pigments, Production, Properties, Applications. 3rd edition. Wiley-VCH, 2004. ISBN 3527305769.

Suitable pigments are disclosed in paragraphs to of WO 2008/074548.

The pigment particles are dispersed in an aqueous medium by means of a polymeric dispersant or a surfactant. Self-dispersible pigments may also be used. If combined with capsules having anionic dispersing groups, anionic surfactants may be preferably used as dispersant for the pigment. A self-dispersible pigment is a pigment having on its surface covalently bonded anionic hydrophilic groups, such as salt-forming groups or the same groups used as dispersing groups for the capsules, that allow the pigment to be dispersed in an aqueous medium without using a surfactant or a resin. Suitable commercially available self-dispersible colour pigments are, for example, the CAB-O-JET™ inkjet colorants from CABOT.

A particularly suitable class of pigments to be included in the inkjet inks of the invention, are encapsulated pigments wherein the pigment is at least partially covered with a polymer, preferably a crosslinked polymer. Suitable examples of encapsulated pigments are described in [0070-0076] of US2014/092168, hereby incorporated by reference.

Pigment particles in inkjet inks should be sufficiently small to permit free flow of the ink through the inkjet-printing device, especially at the ejecting nozzles. It is also desirable to use small particles for maximum colour strength and to slow down sedimentation.

The average pigment particle size is preferably between 0.050 and 1 μm, more preferably between 0.070 and 0.300 μm and particularly preferably between 0.080 and 0.200 μm. Most preferably, the numeric average pigment particle size is no larger than 0.150 μm. The average particle size of pigment particles is determined with a Brookhaven Instruments Particle Sizer BI90plus based upon the principle of dynamic light scattering. The ink is diluted with water to a pigment concentration of 0.002 wt. %. The measurement settings of the BI90plus are: 5 runs at 23° C., angle of 90°, wavelength of 635 nm and graphics=correction function.

However, for white pigment inkjet inks, the numeric average particle diameter of the white pigment is the same as described in § B.1.

Suitable white pigments are given by Table 2 in of WO 2008/074548. The white pigment is preferably a pigment with a refractive index greater than 1.60. The white pigments may be employed singly or in combination. Preferably titanium dioxide is used as pigment with a refractive index greater than 1.60. Suitable titanium dioxide pigments are those disclosed in and in of WO 2008/074548.

Also special colorants may be used, such as fluorescent pigments for special effects in clothing, and metallic pigments for printing a luxury look of silver and gold colours on textiles.

Suitable polymeric dispersants for the pigments are copolymers of two monomers but they may contain three, four, five or even more monomers. The properties of polymeric dispersants depend on both the nature of the monomers and their distribution in the polymer. Co-polymeric dispersants preferably have the following polymer compositions:
statistically polymerized monomers (e.g. monomers A and B polymerized into ABBAABAB);
alternating polymerized monomers (e.g. monomers A and B polymerized into ABABABAB);
gradient (tapered) polymerized monomers (e.g. monomers A and B polymerized into AAABAABBABBB);
block copolymers (e.g. monomers A and B polymerized into AAAAABBBBBB) wherein the block length of each of the blocks (2, 3, 4, 5 or even more) is important for the dispersion capability of the polymeric dispersant;
graft copolymers (graft copolymers consist of a polymeric backbone with polymeric side chains attached to the backbone); and
mixed forms of these polymers, e.g. blocky gradient copolymers.

Suitable dispersants are DISPERBYK™ dispersants available from BYK CHEMIE, JONCRYL™ dispersants available from JOHNSON POLYMERS and SOLSPERSE™ dispersants available from Lubrisol. A detailed list of non-polymeric as well as some polymeric dispersants is disclosed by MC CUTCHEON. Functional Materials, North American Edition. Glen Rock, N.J.: Manufacturing Confectioner Publishing Co., 1990. p.110-129.

The polymeric dispersant has preferably a number average molecular weight Mn between 500 and 30000, more preferably between 1500 and 10000.

The polymeric dispersant has preferably a weight average molecular weight Mw smaller than 100,000, more preferably smaller than 50,000 and most preferably smaller than 30,000.

The pigments are preferably present in the range of 0.01 to 20%, more preferably in the range of 0.05 to 10% by weight and most preferably in the range of 0.1 to 5% by weight, each based on the total weight of the inkjet ink. For white inkjet inks, the white pigment is preferably present in an amount of 3% to 40% by weight of the inkjet ink, and more preferably 5% to 35%. An amount of less than 3% by weight cannot achieve sufficient covering power.

### B.2.3. Resin

The ink jet ink composition according to the invention may further comprise an additional resin. The resin is often added to the ink jet ink formulation to further achieve a good adhesion of the pigment to the substrate or to increase water and solvent resistance of the printed images. The resin is preferably a polymer and suitable resins can be acrylic based resins, a urethane-modified polyester resin or a wax. Suitable waxes are polyethylene wax, polypropylene wax and polytetrafluoroethylene wax, and the like. In an example, the wax is selected from the group consisting of polypropylene waxes, high density polyethylene (HDPE) waxes, and combinations thereof.

The concentration of the resin in the ink jet ink according to the invention is at least 1 (wt.)% and preferably lower than 30 (wt.)%, more preferably lower than 20 (wt.)%.

### B.2.4. Additives

The inkjet ink may also contain humectants. Humectants are preferably incorporated in the inkjet ink if this liquid has to be applied by means of a jetting technique such as inkjet or valve jet. Humectants prevent the clogging of nozzles. The prevention is due to its ability to slow down the evaporation rate of the inkjet ink, especially the water in the liquid. The humectant is preferably an organic solvent having a higher boiling point than water. Suitable humectants include triacetin, N-methyl-2-pyrrolidone, glycerol, urea, thiourea, ethylene urea, alkyl urea, alkyl thiourea, dialkyl urea and dialkyl thiourea, diols, including ethanediols, propanediols, propanetriols, butanediols, pentanediols, and hexanediols; glycols, including propylene glycol, polypropylene glycol, ethylene glycol, polyethylene glycol, diethylene glycol, tetraethylene glycol, and mixtures and derivatives thereof. A preferred humectant is glycerol.

The humectant is preferably added to the liquid formulation in an amount of 0.1 to 20 wt. % based on the total weight of the liquid.

The inkjet ink may contain a surfactant. Any known surfactant may be used but preferably a glycol surfactant and/or an acetylene alcohol surfactant and/or a polysiloxane surfactant is used. The use of the acetylene glycol surfactant and/or the acetylene alcohol surfactant and/or the polysiloxane surfactant further reduces bleeding to improve printing quality, and also improves the drying property in printing to allow high-speed printing.

The acetylene glycol surfactant and/or the acetylene alcohol surfactant is preferably one or more selected from 2,4,7,9-tetramethyl-5-decine-4,7-diol, alkylene oxide adducts of 2,4,7,9-tetramethyl-5-decine-4,7-diol, 2,4-dimethyl-5-decin-4-ol, and alkylene oxide adducts of 2,4-dimethyl-5-decin-4-ol. These are available, for example, from Air Products (GB) or from Nissin Chemical Industry, e.g Olfine (registered trademark) such as Olfine E1010, 104 series and Surfynol (registered trademark) E series, as 465 and Surfynol 61.

### C. Inkjet Printing Method

In a preferred inkjet recording method, the method comprises the steps of:
a) jetting an aqueous inkjet ink on a substrate, the ink comprising a colorant and the capsule consisting of a polymeric shell surrounding a core, the core comprising a second polymer; and
b) drying the jetted inkjet ink by applying heat such as to obtain a temperature of the jetted ink of at least 50° C., more preferably at least 80° C.

Before the jetting of the inkjet ink according to the invention, an aqueous pre-treatment liquid or primer can be applied onto the substrate. The aqueous pre-treatment liquid comprises preferably a component capable of aggregating components of the aqueous inkjet ink of the invention. Examples of such components are flocculants selected from the group consisting of multivalent salts, cationic surfactants and cationic resins.

In another preferred inkjet recording method, the method comprises the steps of: a) applying an aqueous pre-treatment liquid on a substrate, the pre-treatment liquid comprising the dispersion of microcapsules consisting of a polymeric shell and a core, the core comprising a second resin, the polymeric shell comprising a dispersing group selected from the group consisting of a protonated amine, a protonated nitrogen containing heteroaromatic compound, a quaternized tertiary amine, a N-quaternized heteroaromatic compound, a sulfonium and a phosphonium. b) optionally at least partially dry the applied aqueous pre-treatment liquid such as to obtain a temperature of the applied pre-treatment liquid of at least 50° C., more preferably at least 60° C., most preferably at least 80° C.; and c) jetting an aqueous inkjet ink onto the applied pre-treatment liquid, the ink comprising a colorant preferably a pigment and more preferably also comprising the dispersion of microcaps according to the invention; and d) drying the jetted inkjet ink. If step b) was not performed, or the drying of the pre-treatment liquid was not completed, the drying in step d) should be performed by applying heat such that the temperature of the applied pre-treatment liquid is of at least 50° C., more preferably at least 80° C.

The aqueous dispersion according to the invention can also be included in a post-treatment liquid or over-print varnish, which is then preferably jetted by means of an inkjet head.

The substrate in the inkjet recording method may be porous, such as e.g. textile, paper and leather, but preferably a low-absorbing substrate such as card board substrates or non-absorbing substrates such as polyethylene, polypropylene, polycarbonate, polyvinyl chloride, polyesters like polyethylene terephthalate (PET), polyethylene naphthalate (PEN), polylactide (PLA), polymethylmethacrylate or polyimide.

The substrate may also be a paper substrate, such as plain paper or resin coated paper, e.g. polyethylene or polypropylene coated paper. There is no real limitation on the type of paper and it includes newsprint paper, magazine paper, office paper, wallpaper but also paper of higher grammage, usually referred to as boards, such as white lined chipboard, corrugated board and packaging board.

The substrates may be transparent, translucent or opaque. Preferred opaque substrates includes so-called synthetic paper, like the Synaps™ grades from Agfa-Gevaert which are an opaque polyester sheet having a density of 1.10 g/cm³ or more.

In another preferred inkjet recording method, the pre-treatment liquid is applied via a technique selected from the group of ink jetting, valve jetting and spraying. More specifically, these techniques of ink jetting and valve jetting allow, the pre-treatment liquid according to the invention to be applied image wise, preferably onto the surfaces whereupon the inkjet ink will be printed to obtain an image. These last means of applying the pre-treatment liquid has the advantage that the amount of required pre-treatment liquid is substantially lower than with other application methods of priming the substrate.

Examples of the heating process to dry the pre-treatment liquid or the inkjet ink according to the invention include, but are not limited to, heat press, atmospheric steaming, high-pressure steaming, THERMOFIX. Any heat source can be used for the heating process; for example, an infrared ray source is employed.

The drying step can be performed at the air, but the heating step must be performed by using heat sources; examples include equipment for forced-air heating, radiation heating such as IR-radiation, including NIR-, CIR- and SWIR radiation, conduction heating, high-frequency drying, and microwave drying. The drying step is such that a temperature of the printed images is preferably obtained below 150° C.

A preferred ink jet head for the inkjet printing system to jet the inkjet ink or pre-treatment liquid comprising the resin particles according to the invention is a piezoelectric ink jet head. Piezoelectric inkjet jetting is based on the movement of a piezoelectric ceramic transducer when a voltage is applied thereto. The application of a voltage changes the shape of the piezoelectric ceramic transducer in the print head creating a void, which is then filled with ink or liquid. When the voltage is again removed, the ceramic expands to its original shape, ejecting a drop of ink from the ink jet head. However, the jetting of the aqueous inkjet ink or aqueous pre-treatment liquid comprising the particle dispersion according to the present invention is not restricted to piezoelectric inkjet printing. Other inkjet print heads can be used and include various types, such as a continuous type, a thermal print head type, a MEM-jet type head and a valve jet type.

### D. Examples

### D.1. Materials

All materials used in the following examples were readily available from standard sources such as Sigma-Aldrich (Belgium) and Acros (Belgium) unless otherwise specified. The water used was demineralised water.
Dynacoll 7150 is a polyester polyol containing terephthalic ester and isophthalic ester units supplied by Evonik
Ymer N90 is 1,3 diol polyether supplied by Perstorp
Ymer N120 is 1,3 diol polyether supplied by Perstorp
Reaxis C708 is a catalyst supplied by Reaxis BV
IPDI is an IPDI monomer supplied by Evonik
Vestanat T1890E IPDI, is a 70% IPDI trimer solution in butyl acetate, supplied by Evonik
Desmodur N3200 is an HDI based polyisocyanurate supplied by Covestro
Desmodur N75 is a HDI biuret from Covestro
Lakeland ACP70 is a 70% solution of a N-coco alkyl β-alanine derivative, supplied by Espachem
BD is 1,4-butane diol supplied by Acros
Triethylamine is triethylamine supplied by Acros
PU-3 is an aqueous dispersion of a polyurethane resin and is prepared as the resin PU-3 in WO2019/106089 A.
2,2′-Azobis(2-methylbutyronitrile) is an initiator obtained from Wako Chemicals
NeoCryl A-1127 is a 44 wt. % aqueous polyacrylate dispersion from DSM NeoResins
Mowinyl 6969D is a 42 wt. % aqueous polyacrylate dispersion from Japan Coating Resin Corporation
PD is 1,2-propanediol, manufactured by Dow Chemical
DPM is Dowanol DPM, manufactured by Dow Chemical
SolvMIX is a 1:1 mixture of Dowanol DPM and glycol
COL-1 is a commercial cyan dispersion supplied by Lubrizol, available under the trade name Diamond D75C
COL-2 is a 15% aqueous dispersion of pigment red 122 from Lubrizol, available under the trade name DIAMOND D75M
HD is 1,2-hexanediol
SURF-1 is Tegowet 270 supplied by Evonik
SUBST-1 is an MM-X liner of 180 gsm supplied by MM Karton
SUBST-2 is a clay coated EB flute supplied by Antalis
SUBST-3 is a polypropylene film supplied by Antalis as Pripak Classic

### D.2. Measuring Methods

### D.2.1. Sample Preparation

Inkjet ink formulations were coated with an automated bar coater using a 10 μm spiral bar on the respective substrates. After drying the coated film for 5 minutes in an oven at 80° C., it could be further evaluated.

Inkjet ink formulations were jetted with a Dimatix™ DMP2831 system, equipped with a standard Dimatix™ 10 pl print head. The ink was jetted at 22° C., using a firing frequency of 5 kHz, a firing voltage of 25 V and a standard waveform. The inks were jetted on SUBST-3 and dried at 100° C. for 5 minutes such as to obtain solid colour patches.

### D.2.2. Water Resistance

Water resistance was evaluated on the dried coatings by performing 5 double rubs with a Q tip soaked with water on the substrate. Level of water resistance was quantified according to the criteria in Table 1 below.

D.2.3. Water-solvent resistance

The jetted and dried solid patches were evaluated towards their water and i-propanol resistance by rubbing with a Q-tip 10 times. The level of water and solvent resistance was quantified according to the criteria in Table 1.

TABLE 1

| Level of water & solvent resistance | Score |
|---|---|
| No or very limited influence on film appearance | 1 |
| Slight influence on film appearance/substrate slightly | 2 |
| visible | |
| Strong influence on film appearance/substrate strongly | 3 |
| visible | |

### D.2.4. Rub Resistance

Rub resistance was evaluated on the dried film by performing 10 double rubs with a white adjacent fibre as in ISO105-X12. Coloration of the white rubbing cloth is evaluated based on the ΔEab (CIE76) as shown in Table 2.

TABLE 2

| ΔEab | Score |
|---|---|
| ΔE < 8.5 | 1 |
| 10 ≥ ΔE ≥ 8.5 | 2 |
| ΔE > 10 | 3 |

### D.2.5. Ink Jetting Reliability

Inkjet ink formulations were jetted as described in § D.2.1.

The evaluation of the latency was based on the amount of fully functional nozzles of the inkjet head after restarting the jetting process after 2 minutes of idle time (1=all nozzles still jet, 2=more than half of the nozzles still jet, 3=less than half of the nozzles jets) with the nozzles uncapped.

### D.3. Preparation of Inventive Microcapsules

### D.3.1. Preparation of the Second Polymers: Polyurethane Resins

### PU-1 Solution

First, a polyurethane-solution PU-1 is prepared according to following steps. 227.49 g of Dynacol 7150 was dissolved in 402.83 g of ethyl acetate at 45° C. in an Erlenmeyer. 56.87 g of Ymer N120 was added to the Dynacol solution. Ymer N120 was firstly preheated at 90° C. in order to become liquid and become more easy to handle. A clear solution in ethyl acetate was thus obtained. The mixture was allowed to cool to room temperature. A catalyst solution was prepared by dilution of 2.14 g of Reaxis C708 with 19.34 g of ethyl acetate. The mixture of Ymer N120 and Dynacol 7150 was transferred to a 1000 mL three-necked round-bottom flask equipped with a coiled condenser and an overhead stirrer. The flask was flushed with nitrogen and slow nitrogen flow was maintained during stirring and reaction. Subsequently the catalyst was added dropwise via an addition funnel with pressure equalization arm. The oil bath was heated to 75° C. After 1 hour, the reaction mixture reaches a constant temperature of 68° C. Subsequently 31.32 g of IPDI was added via an addition funnel with pressure equalization arm during 35 minutes. Then the oil bath was put to 70° C. and the reaction was allowed to react overnight during 22 hours. After reacting overnight, the oil bath was put again to 75° C. for 30 minutes and then cooled to room temperature. A theoretical solids content of 42.98% of the PU-1 solution was used for further use.

### PU-2 Solution

A polyurethane solution PU-2 was prepared by the following steps. 260.08 g of Dynacol 7150 was dissolved in 402,90 g of ethyl acetate at 45° C. in an Erlenmeyer. 28.90 g of Ymer N90 was added to the Dynacol solution. Ymer N90 was firstly preheated at 90° C. in order to become liquid and become more easy to handle. A clear solution in ethyl acetate was thus obtained. The mixture was allowed to cool to room temperature. A catalyst solution was prepared by dilution of 2.14 g of Reaxis C708 with 19.34 g of ethyl acetate. The polyol solution was transferred to a 1000 mL three-necked round-bottom flask equipped with a coiled condenser and an overhead stirrer. The flask was flushed with nitrogen and slow nitrogen flow was maintained during stirring and reaction. Subsequently the catalyst was added dropwise via an addition funnel with pressure equalization arm. The oil bath was heated to 75° C. After 1 hour the reaction mixture reaches a constant temperature of 68° C. Subsequently 26.70 g of IPDI was added via an addition funnel with pressure equalization arm during 40 minutes. Then the oil bath was put to 70° C. and the reaction was allowed to react overnight during 22 hours. After reacting over night the oil bath was put again to 75° C. for 30 minutes and then cooled to room temperature. A theoretical solids content of 42,98% of the PU-2 solution was used for further use.

### PU-4 Solution

A polyurethane solution PU-4, was prepared by the following steps. 114.63 g of Dynacol 7150 was dissolved in 201.45 g of ethyl acetate at 45° C. in an Erlenmeyer. 28.66 g of Ymer N90 was added to the Dynacol solution. Ymer N90 was firstly preheated at 90° C. in order to become liquid and become more easy to handle. A clear solution in ethyl acetate was thus obtained. The mixture was allowed to cool to room temperature. A catalyst solution was prepared by dilution of 1.07 g of Reaxis C708 with 9.67 g of ethyl acetate. The polyol solution was transferred to a 500 ml three-necked round-bottom flask equipped with a coiled condenser and an overhead stirrer. The flask was flushed with nitrogen and slow nitrogen flow was maintained during stirring and reaction. Subsequently the catalyst was added dropwise via an addition funnel with pressure equalization arm. The oil bath was heated to 75° C. After 1 hour, the reaction mixture reaches a constant temperature of 68° C. Subsequently 14.56 g of IPDI was added via an addition funnel with pressure equalization arm during 35 minutes. Then the oil bath was put to 70° C. and the reaction was allowed to react overnight during 22 hours. After reacting over night the oil bath was put again to 75° C. for 30 minutes and then cooled to room temperature. A theoretical solids content of 42,98% for PU-4 solution was used for further use.

### D.3.2. Preparation of the Second Polymers: Polyacrylic Resins PMMA-1

PMMA-1 is a polymethyl methacrylate synthesized as follows: 10 g of methyl methacrylate was dissolved in 30 mL ethyl acetate in a three-neck flask of 100 mL. The clear solution is flushed during 10 minutes with nitrogen, after which 0.506 g of 1-dodecanethiol is added. The mixture is again flushed with nitrogen for 10 minutes. 0.288 g of 2,2′-Azobis(2-methylbutyronitrile) is added and the reaction mixture is refluxed overnight. The reaction is followed using TLC (NP Merck 90/10 heptane/Ethyl acetate and I2 staining). After all the monomer is consumed, the solvent is evaporated and a solid product is obtained.

The polyacrylate was analysed with Size Exclusion Chromatography (3×mixed B column set, THF/HOAc 95/5). The results of the measurements are listed in Table 3

TABLE 3

| | Mn | Mw | Mp | |
|---|---|---|---|---|
| | (g/mol) | (g/mol) | (g/mol) | Dispersity |
| PMMA-1 | 3000 | 5200 | 4800 | 1.69 |

### D.3.3. Preparation of Inventive Microcapsule Dispersion

An inventive microcapsule dispersion CAP-1 was prepared via interfacial polymerization. The oleophilic phase was prepared by mixing: 25.73 g of ethyl acetate, 16.5 g of Desmodur N3200 and 38.42 g of the PU-1 solution. An aqueous phase was prepared by mixing: 7.00 g of Lakeland ACP70, 1.80 g of lysine and 2.0 g of triethylamine and 102.94 g water. The organic phase was brought in a plastic bottle having a wide opening and was placed in an ice bath. The aqueous phase was added to the oleophilic phase. The oleophilic phase was emulsified in the aqueous phase at 18000 RPM using an Ultraturrax device during 5 minutes. The emulsion was brought in a round bottom flask. In order to transfer everything of the dispersion, the plastic bottle was rinsed using 80.00 g of water. The ethyl acetate was evaporated on a rotary evaporator until a weight of 145 g. The temperature was set to 40° C. and the ethyl acetate was removed under reduced pressure. The evaporation was started at a pressure of 200 mbar and the pressure was gradually decreased till 40 mbar. When too much water was evaporated, this water was compensated by addition up to 145 g in total. The round bottom flask was placed in an oil bath which has a temperature of 40° C. and was heated within 30 minutes to 60° C. The dispersion was then kept overnight at 60° C. during 16 hours and then cooled to room temperature. The resulting microcaps dispersion CAP-1 had a solids content of 32.09 wt. %, a pH of 7.88 and the average particle size was 208.7 nm (determined by a Malvern particle sizer).

An inventive microcapsule dispersion CAP-2 was prepared via interfacial polymerization. The oleophilic phase was prepared by mixing: 25.73 g of ethyl acetate, 16.5 g of Desmodur N3200 and 38.42 g of the PU-4 solution. An aqueous phase was prepared by mixing: 7.00 g of Lakeland ACP70, 1.80 g of lysine and 2.0 g of triethylamine and 103.28 g water. The oleophilic phase was brought in a plastic bottle having a wide opening and was placed in an ice bath. The aqueous phase was added to the oleophilic phase. The oleophilic phase was emulsified in the aqueous phase at 18000 RPM using an Ultraturrax device during 5 minutes. The emulsion was brought in a round bottom flask. In order to transfer everything of the emulsion, the plastic bottle was rinsed using 80.00 g of water. The ethyl acetate was evaporated on a rotary evaporator until a weight of 145 g. The temperature was set to 40° C. and the ethyl acetate was removed under reduced pressure. The evaporation was started at a pressure of 200 mbar and the pressure was gradually decreased till 40 mbar. When too much water was evaporated, this water was compensated by addition up to 145 g in total. The round bottom flask was placed in an oil bath which has a temperature of 40° C. and was heated within 30 minutes to 60° C. The dispersion was then kept overnight at 60° C. during 16 hours and then cooled to room temperature. The resulting microcaps dispersion CAP-2 had a solids content of 25.44 wt. %, a pH of 7.12 and the average particle size was 200.2 nm (determined by a Malvern particle sizer).

An inventive microcapsule dispersion CAP-3 was prepared via interfacial polymerization. The oleophilic phase was prepared by mixing: 24.56 g of ethyl acetate, 12.19 g of Vestanat T1890E IPDI and 19.86 g of PU-2 solution. An aqueous phase was prepared by mixing: 3.62 g of Lakeland ACP70, 0.93 g of lysine and 1.04 g of triethylamine and 103.28 g water. The oleophilic phase was brought in a plastic bottle having a wide opening and was placed in an ice bath. The aqueous phase was added to the oleophilic phase. The oleophilic phase was emulsified in the aqueous phase at 18000 RPM using an Ultraturrax device during 5 minutes. The emulsion was brought in a round bottom flask. In order to transfer everything of the emulsion, the plastic bottle was rinsed using 80.00 g of water. The ethyl acetate was evaporated on a rotary evaporator until a weight of 75 g. The temperature was set to 40° C. and the ethyl acetate was removed under reduced pressure. The evaporation was started at a pressure of 200 mbar and the pressure was gradually decreased till 40 mbar. When too much water was evaporated, this water was compensated by addition up to 75 g in total. The round bottom flask was placed in an oil bath which has a temperature of 40° C. and was heated within 30 minutes to 60° C. The dispersion was then kept overnight at 60° C. during 16 hours and then cooled to room temperature. The resulting microcaps dispersion CAP-3 had a solids content of 26.68 wt. %, a pH of 7.43 and the average particle size was 171.1 nm (determined by a Malvern particle sizer).

An inventive microcapsule dispersion CAP-4 was prepared via interfacial polymerization. The oleophilic phase was prepared by mixing: 24.56 g of ethyl acetate, 12.19 g of IPDI Vestanat T1890E IPDI and 19.86 g of the PU-2 solution. An aqueous phase was prepared by mixing: 3.62 g of Lakeland ACP70, 0.93 g of lysine and 0.622 g of 28% NH₄OH solution in water and 54.29 g water. The oleophilic phase was brought in a plastic bottle having a wide opening and was placed in an ice bath. The aqueous phase was added to the oleophilic phase. The oleophilic phase was emulsified in the aqueous phase at 18000 RPM using an Ultraturrax device during 5 minutes. The emulsion was brought in a round bottom flask. In order to transfer everything of the emulsion, the plastic bottle was rinsed using 80.00 g of water. The ethyl acetate was evaporated on a rotary evaporator until a weight of 75 g. The temperature was set to 40° C. and the ethyl acetate was removed under reduced pressure. The evaporation was started at a pressure of 200 mbar and the pressure was gradually decreased till 40 mbar. When too much water was evaporated, this water was compensated by addition up to 75 g in total. The round bottom flask was placed in an oil bath which has a temperature of 40° C. and was heated within 30 minutes to 60° C. The dispersion was then kept overnight at 60° C. during 16 hours and then cooled to room temperature. The resulting microcaps dispersion CAP-4 had a solids content of 25.52 wt. %, a pH of 7.43 and the average particle size was 239.1 nm (determined by a Malvern particle sizer).

The inventive microcap dispersion CAP-5, including a second polymer as a polyacrylate, was prepared as follow:

In POT A 3.5 g of PMMA-1 was added to 10 g Ethyl acetate, together with 4.657 g of Desmodur N75 and 0.7 g Lakeland ACP70. In POT B, 1.120 g of Lakeland ACP70, 0.469 g of L-Lysine and 0.400 g of triethanolamine were added to 17.5 g of water. POT A was added to POT B and stirred during 5 minutes under high shear using an Ultra-Turrax at 15000 rpm. The solvent was removed under reduced pressure and any water that was removed was added afterwards. A capsule dispersion with 27.4 wt. % dry residue was obtained.

The capsule dispersion was evaluated microscopically and the particle size was determined with a nanosizer (Malvern).

An overview of the properties of the CAP-5 dispersion is given in Table 4.

TABLE 4

| | | average | | dry |
|---|---|---|---|---|
| | Encapsulated | particle | | residue |
| | polymer | size (nm) | PDI | (wt %) |
| CAP-5 | PMMA-1 | 199 | 0.17 | 20 |

The dispersion has a good microscopic quality.

### D.4. Preparation of Aqueous Inkjet Inks

### D.4.1. Aqueous Inkjet Inks Comprising a PU Polymer.

Three cyan inkjet inks were prepared by mixing the compounds given in Table 5. All weight percentages are relative to the total weight of the inkjet inks. If a resin or microcaps was used in the ink formulation, the solid content of the resin/microcap is 6.0 wt. % of total weight of the ink.

TABLE 5

| Ingredient | INVINK-1 | COMPINK-1 | COMPINK-2 |
|---|---|---|---|
| PD | 10% | 10% | 10% |
| DPM | 5% | 5% | 5% |
| SURF-1 | 0.6% | 0.6% | 0.6% |
| PU-3 | — | — | 6% solids |
| CAP-1 | 6% solids | — | — |
| COL-1 | 20% | 20% | 20% |
| WATER | To complete | To complete | To complete |
| | to 100% | to 100% | to 100% |

### D.4.2. Preparation of Aqueous Inkjet Inks Comprising a Polyacrylate Polymer.

In Table 6, the compositions of the inventive ink comprising the encapsulated polyacrylate polymer and of the comparative inks, comprising a polyacrylate polymer which is not encapsulated, are summarized.

The inventive ink INVINK-2 was formulated as follows: 3,962 g of CAP-5 was mixed together with 2,28 g of COL-2 and stirred at room temperature. 3,962 g of SolvMIX was added dropwise and the ink was stirred 5 minutes at room temperature and filtered (1.6 μm). All inks obtained were stable for 2 weeks at room temperature.

Comparative inks, COMPINK-3 and COMPINK-4 were made by first diluting Mowinyl 6969D and NeoCryl A-1127 with water to obtain a same solid concentration in the ink. Afterwards, 2,28 g of COL-2 was added and the mixture was stirred at room temperature. 3,962 g of the SolvMIX was added dropwise and the ink was stirred 5 minutes at room temperature and filtered (1.6 μm).

TABLE 6

| Amount in g | INVINK-2 | COMPINK-3 | COMPINK-4 |
|---|---|---|---|
| CAP-5 | 3.962 | | |
| Mowinyl 6969D | | 2.44 | |
| NeoCryl A-1127 | | | 2.44 |
| Water | | 1.56 | 1.56 |
| COL-2 | 2.28 | 2.28 | 2.28 |
| SolvMIX | 3.962 | 3.962 | 3.962 |

D.5. Evaluation of Physical Properties of Coatings Obtained with INVINK-1, COMPINK-1 and COMPINK-2.

The inks from Table 5 were coated on SUBST-1 and SUBST-2 (see § D.2.1.) and evaluated as described in D.2.2. and D.2.4. The results of the evaluation are summarized in Table 7.

TABLE 7

| | | Water | Rub |
|---|---|---|---|
| | Substrate | resistance | resistance |
| INVINK-1 | Subst-1 | 1 | 1 |
| COMPINK-1 | Subst-1 | 3 | 1 |
| COMPINK-2 | Subst-1 | 1 | 3 |
| INVINK-1 | Subst-2 | 1 | 1 |
| COMPINK-1 | Subst-2 | 2 | 1 |
| COMPINK-2 | Subst-2 | 1 | 3 |

From the results in Table 7, it is clear that the ink according to the invention scores well on both water resistance and rub resistance. When using no binder/resin in the ink, the water resistance is insufficient although the rub resistance is still OK. When adding a PU binder as a latex to the ink, the water resistance is improved, but the rub resistance is still insufficient.

### D.6. Evaluation of Inks INVINK-2 and COMPINK-3 & 4.

The water and solvent resistance of solid patches of the jetted inks (see § D.2.1.) from Table 6 were evaluated according to § D.2.3. The results are summarized in Table 8.

The jetting reliability of the inks was evaluated as described in § D.2.5. The results are listed in column ‘latency’ of Table 8.

TABLE 8

| | i-propanol | Water | |
|---|---|---|---|
| INK | resistance | resistance | latency |
| INVINK-2 | 1 | 1 | 1 |
| COMPINK-3 | 3 | 3 | 2 |
| COMPINK-4 | 3 | 1 | 3 |

From Table 8 it can be concluded that besides excellent water and solvent resistance of the jetted and dried inventive ink inks comprising the microcaps dispersion of the invention, a more reliable jetting after a restart is obtained than with the comparative inks.

1-11. (canceled)

12. An aqueous dispersion of a microcapsule, the microcapsule comprising a crosslinked polymeric shell surrounding a core, wherein the core comprises a second polymer, where the second polymer is free of an ethylenically unsaturated group, an epoxy group, an isocyanate group, a β-keto-ester, a β-keto-amide, or a 1,3-diketone.

13. The aqueous dispersion of claim 12, wherein the polymeric shell comprises a polymer selected from the group consisting of poly(urea), poly(urethanes), poly(amides), poly(esters), poly(carbonates), poly(sulfonamides), and combinations thereof.

14. The aqueous dispersion of claim 12, wherein the second polymer is selected from the group consisting of poly(urethanes) and copolymers thereof, acrylics and copolymers thereof, poly(esters), poly(styrenes) and copolymers thereof, poly(vinyl amides) and copolymers thereof, poly(olephines) and copolymers thereof, poly(vinyl alcohol) derivatives and copolymers thereof, poly(acetals) and copolymers thereof, poly(ethers) and copolymers thereof, poly(vinyl ethers) and copolymers thereof, polyvinyl(esters) and copolymers thereof, poly(imides) and copolymers thereof, poly(imines) and copolymers thereof, polycarbonates and copolymers thereof, poly(vinyl chloride) and copolymers thereof, poly(vinylidene chloride) and copolymers thereof poly(amic acids) and copolymers thereof, poly(saccharides) and derivatives thereof, and cellulose and derivatives thereof.

15. The aqueous dispersion of claim 12, wherein a dispersing group is covalently bonded to the polymeric shell.

16. The aqueous dispersion of claim 14, wherein a dispersing group is covalently bonded to the polymeric shell.

17. The aqueous dispersion of claim 15, wherein the dispersing group is selected from the group consisting of a carboxylic acid or salt thereof, a sulfonic acid or salt thereof, a phosphoric acid ester or a salt thereof, and a phosphonic acid or salt thereof.

18. The aqueous dispersion of claim 16, wherein the dispersing group is selected from the group consisting of a carboxylic acid or salt thereof, a sulfonic acid or salt thereof, a phosphoric acid ester or a salt thereof, and a phosphonic acid or salt thereof.

19. The aqueous dispersion of claim 15, wherein the dispersing group is selected from the group consisting of a protonated amine, a protonated nitrogen containing heteroaromatic compound, a quaternized tertiary amine, a N-quaternized heteroaromatic compound, a sulfonium, and a phosphonium.

20. The aqueous dispersion of claim 16, wherein the dispersing group is selected from the group consisting of a protonated amine, a protonated nitrogen containing heteroaromatic compound, a quaternized tertiary amine, a N-quaternized heteroaromatic compound, a sulfonium, and a phosphonium.

21. An aqueous inkjet ink comprising a colorant and the aqueous dispersion as defined in claim 12.

22. An aqueous inkjet ink comprising a colorant and the aqueous dispersion as defined in claim 14.

23. An aqueous inkjet ink comprising a colorant and the aqueous dispersion as defined in claim 15.

24. An aqueous inkjet ink comprising a colorant and the aqueous dispersion as defined in claim 18.

25. A pre-treatment liquid comprising a compound capable of precipitating or aggregating a compound from an aqueous inkjet ink and the aqueous dispersion according to claim 19.

26. A method of preparing the microcapsule dispersion as defined in claim 12 comprising the following steps:
a) preparing a first solution by dissolving the second polymer and a first shell monomer in a substantially water immiscible solvent;
b) preparing a second solution by dissolving an emulsifier and optionally a second shell monomer in water;
c) emulsifying the first solution in the second solution;
d) optionally evaporating the substantially water immiscible solvent; and
e) initiating shell formation by interfacial polymerization.

27. An inkjet recording method comprising the steps of:
a) jetting an inkjet ink comprising a colorant and the aqueous dispersion as defined in claim 12 on a substrate; and
b) drying the jetted inkjet ink by applying heat to obtain a temperature of the jetted ink of at least 50° C.

28. An inkjet recording method comprising the steps of:
a) jetting an inkjet ink comprising a colorant and the aqueous dispersion as defined in claim 14 on a substrate; and
b) drying the jetted inkjet ink by applying heat to obtain a temperature of the jetted ink of at least 50° C.

29. An inkjet recording method comprising the steps of:
a) jetting an inkjet ink comprising a colorant and the aqueous dispersion as defined in claim 15 on a substrate; and
b) drying the jetted inkjet ink by applying heat to obtain a temperature of the jetted ink of at least 50° C.

30. An inkjet recording method comprising the steps of:
a) jetting an inkjet ink comprising a colorant and the aqueous dispersion as defined in claim 18 on a substrate; and
b) drying the jetted inkjet ink by applying heat to obtain a temperature of the jetted ink of at least 50° C.

31. An inkjet recording method comprising the steps of:
a) applying a pre-treatment liquid comprising a compound capable of precipitating or aggregating a compound from an aqueous inkjet ink and the aqueous dispersion according to claim 19 on a substrate; and
b) optionally at least partially drying the pre-treatment liquid to obtain a temperature of the pre-treatment liquid of at least 50° C.
c) jetting an aqueous inkjet ink comprising a colorant onto the applied pre-treatment liquid; and
d) drying the jetted inkjet ink and if step b) was not performed, drying the pre-treatment liquid by applying heat to obtain a temperature of the pre-treatment liquid of at least 50° C.
